(19) United States
(12) Patent Application Publication
(10) Pub. No.: US 2026/0230228 A1
(43) Pub. Date: Aug. 6, 2026

(54) WIRELESS COMMUNICATION CONTROL DEVICE

(71) Applicant: Sony Group Corporation, Tokyo (JP)

(72) Inventors: Yusuke TANAKA, Tokyo (JP); Ryuichi HIRATA, Tokyo (JP)

(73) Assignee: Sony Group Corporation, Tokyo (JP)

(21) Appl. No.: 19/148,031

(22) PCT Filed: Mar. 11, 2024
(86) PCT No.: PCT/JP2024/009222

§ 371 Date: Jul. 15, 2025

(30) Foreign Application Priority Data
Mar. 10, 2023 (JP) 2023-038063

(51) Int. Cl. H04L 1/08; H04W 72/12; H04W 76/15

(52) U.S. Cl. CPC H04L 1/08; H04W 72/12; H04W 76/15

(57) ABSTRACT

A wireless communication control device comprises circuitry configured to connect to a first device via a first link and a second link; communicate with the first device via the first link during a first period; and transmit, via the first link, a retransmission request to the first device for schedule information for scheduling communication over the second link.

### CROSS REFERENCE TO RELATED APPLICATIONS

This application claims the benefit of Japanese Priority Patent Application JP 2023-038063 filed Mar. 10, 2023, the entire contents of which are incorporated herein by reference.

### TECHNICAL FIELD

The present disclosure relates to a wireless communication control device.

### BACKGROUND ART

Fast data transfer is demanded for communication of high-image-quality/high-resolution videos like 4k or 8K and communication of XR such as VR, AR, or MR. As a method that meets such a demand for high transfer speeds, there is wireless communication using a plurality of links (Multi Link Operation: MLO). In a wireless communication device (Multi Link Device: MLD) that supports this MLO, due to a relation in terms of frequency among a plurality of links or inadequate isolation resulting from size-related constraints of the device or the like, inter-link interference in which signals of the plurality of links interfere with each other in the wireless communication device can occur. In this case, for example, a transmission signal on one link interferes with a reception signal on another link, and reception or career sensing on the latter link is inhibited. Because of this, transmission and reception cannot be performed simultaneously on the plurality of links. In this manner, in wireless communication devices that support MLO, there can be wireless communication devices (Non-Simultaneous TxRx MLDs: NSTR MLDs) that cannot perform transmission and reception simultaneously on a plurality of links due to intra-device inter-link interference.

An NSTR MLD cannot correctly receive information transmitted by a connection-destination wireless communication device on a link that is experiencing intra-device interference. For example, a case where schedule information regarding communication cannot be received on the link is considered. It is assumed here that the schedule information regarding communication is Power Save information (Target Wake Time Service Period: TWT SP, etc.). In a case where the NSTR MLD cannot receive Power Save information for itself, the NSTR MLD cannot enter a Doze state, and the electric power consumption increases. In addition, in a case where another wireless communication device erroneously determines that the NSTR MLD has received the Power Save information described above and has entered a Doze state and the other wireless communication device is communicating with a device other than the NSTR MLD, there is a possibility that the NSTR MLD that has not actually entered a Doze state performs unexpected communication, and inhibits the communication of the another wireless communication device. In addition, as another example, in a case where the NSTR MLD cannot receive information for giving such a notice that another wireless communication device enters a Doze state, there is a possibility that the NSTR MLD performs unnecessary communication with the another wireless communication device that has entered a Doze state.

A published contribution (20/0613r6) of IEEE 802.11 illustrates a problem that, due to intra-device interference, transmission on one link interferes with another link, media information on the latter link is lost, and this disables transmission on the latter link. The media information is information regarding the use status of a wireless medium (space), and includes a prohibited period (NAV period, etc.) of transmission to the wireless medium, for example. Regarding this problem of a loss of media information, the published contribution described above discloses AP Assisted Recovery (AAR) that makes it possible to promptly resume transmission on another link by causing a connection-destination wireless communication device to provide notification of the media information. However, this published contribution mentions only about a loss of media information and does not mention about a loss of Power Save information.

Power Save information is an example of schedule information regarding communication, and a problem similar to the problem described above can occur also in a case where reception of schedule information regarding communication which is information other than Power Save information has failed.

### CITATION LIST

### Non Patent Literature

NPL 1: IEEE802.11-20/0613r6

### SUMMARY

### Technical Problem

The present disclosure provides a wireless communication control device and a wireless communication control method that suppress the influence on other communication that can occur in a case where reception of schedule information regarding communication has failed on one link in a plurality of links.

### Solution to Problem

A wireless communication control device of an embodiment of the present disclosure comprises circuitry configured to connect to a first device via a first link and a second link; communicate with the first device via the first link during a first period; and transmit, via the first link, a retransmission request to the first device for schedule information for scheduling communication over the second link.

### BRIEF DESCRIPTION OF DRAWINGS

FIG. 1 is a figure depicting an example of an overall configuration of a wireless communication system of an embodiment of the present disclosure.

FIG. 2 is a block diagram of an AP MLD including a wireless communication control device according to the embodiment of the present disclosure.

FIG. 3 is a block diagram of a Non-AP MLD including the wireless communication control device according to the embodiment of the present disclosure.

FIG. 4 is a sequence diagram depicting an example of operations of the AP MLD and non-AP MLDs.

FIG. 5 depicts figures depicting frame format examples of a signal representing a retransmission request for schedule information and a request for an operation related to the recovery of media information.

FIG. 6 depicts figures depicting frame format examples of a signal including schedule information transmitted on a link 1.

FIG. 7 depicts figures depicting frame format examples of a signal that is transmitted on a link 2 and is for recovering the schedule information and also for recovering the media information.

FIG. 8 depicts figures depicting other frame format examples of the signal that is transmitted on the link 2 and is for recovering the schedule information and also for recovering the media information.

FIG. 9 is a block diagram depicting a configuration example of hardware of a computer that executes a series of processing according to the present embodiment in accordance with a program.

FIG. 10 is a block diagram depicting a schematic configuration example of a smartphone to which the present embodiment is applied.

FIG. 11 is a block diagram depicting a schematic configuration example of a vehicle-mounted device to which the present embodiment is applied.

FIG. 12 is a block diagram depicting a schematic configuration example of a wireless AP to which the present embodiment is applied.

### DESCRIPTION OF EMBODIMENT

Hereinbelow, an embodiment of the present disclosure is explained in detail with reference to the figures. Note that explanations of constituent elements having substantially identical functions are omitted as appropriate by giving them identical reference signs in the present specification and figures. The figures are drawn in simplified manners, and it is assumed that constituent elements that are other than those drawn in the figures and are necessary in terms of implementation are also included appropriately. In addition, in a case where such terms as “first” and “second” are used in the present specification or claims, such use does not represent any order or importance and is for making distinctions between a constituent element and other constituent elements, unless noted otherwise.

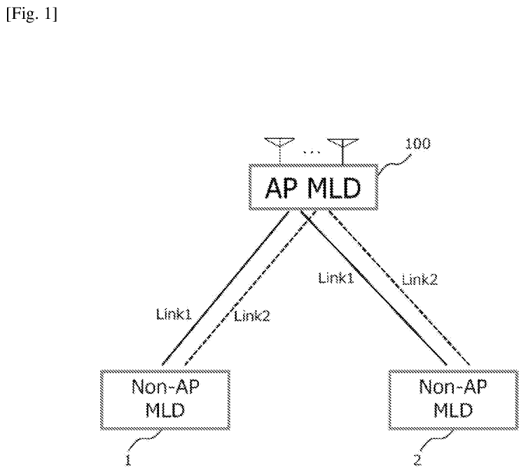

FIG. 1 depicts an example of an overall configuration of a wireless communication system of the embodiment of the present disclosure. The wireless communication system in FIG. 1 includes an AP MLD (Multi Link Device) 100, a Non-AP MLD 1, and a Non-AP MLD 2. The Non-AP MLD 1 and the Non-AP MLD 2 are collectively written as Non-AP MLDs 1/2.

Note that the AP MLD 100 and the Non-AP MLDs 1/2 may also perform operations as a base station and terminals of a wireless LAN according to an IEEE802.11 standard such as IEEE 802.11a/b/g/n/ac/ax/be, as operations other than operations explained in the present embodiment. For example, the AP MLD 100 and the Non-AP MLDs 1/2 may perform operations according to CSMA/CA (Carrier Sense Multiple Access with Carrier Avoidance) as a basic access scheme, and the AP MLD 100 may transmit beacon signals at certain time intervals (periodically).

The Non-AP MLDs 1/2 are first wireless communication devices corresponding to terminals supporting MLO. The AP MLD (MultiLink Device) 100 is a second wireless communication device corresponding to a base station supporting MLO.

The Non-AP MLDs 1/2 are connected wirelessly to the AP MLD 100. Being connected wirelessly means a state where parameters necessary for communication have been exchanged in advance by an association process or the like. The AP MLD 100 is connected with each of the Non-AP MLDs 1/2 on a link 1, which is a first link, and on a link 2, which is a second link. Links are wireless transfer paths that allow data transfer between two communication devices, and may also be written as wireless links.

The link 1 corresponds to the first link connected between the AP MLD 100 and each of the Non-AP MLDs 1/2, and the link 2 corresponds to the second link connected between the AP MLD 100 and each of the Non-AP MLDs 1/2.

Note that the link 1 between the Non-AP MLD 1 and the AP MLD 100 and the link 1 between the Non-AP MLD 2 and the AP MLD 100 have the same frequency or frequency band. The link 2 between the Non-AP MLD 1 and the AP MLD 100 and the link 2 between the Non-AP MLD 2 and the AP MLD 100 have the same frequency or frequency band.

It is assumed that the frequency or frequency band of the link 1 is different from the frequency or frequency band of the link 2, but this does not preclude a case where the frequency or frequency band of the link 1 is the same as the frequency or frequency band of the link 2. In addition, the number of links connected between the AP MLD 100 and each of the Non-AP MLDs 1/2 is two, but can also be three or greater.

Intra-device isolation in the Non-AP MLDs 1/2 is inadequate, and inter-link interference in which signals of the link 1 and the link 2 interfere with each other in a device occurs in the Non-AP MLDs 1/2. Because of this, transmission or reception on the link 1 and transmission or reception on the link 2 cannot be performed simultaneously in each of the Non-AP MLDs 1/2. Such an MLD is called an NSTR (Non-Simultaneous TxRx) MLD. In the present embodiment, the Non-AP MLDs 1/2 are NSTR MLDs.

Note that, typically, such a fact that the Non-AP MLDs 1/2 are NSTR MLDs is recognized in advance at the time of designing, manufacturing, or the like of the devices, and the Non-AP MLDs 1/2 may perform operations of suppressing deterioration of the communication efficiency on the basis of the premise that the devices are NSTR MLDs. For example, the Non-AP MLDs 1/2 may be configured not to start an operation of transmission on one link at the time of reception on the other link. It should be noted that configuring the Non-AP MLDs 1/2 in such a manner is not necessary for realizing the present embodiment.

### Configuration Example of AP MLD 100

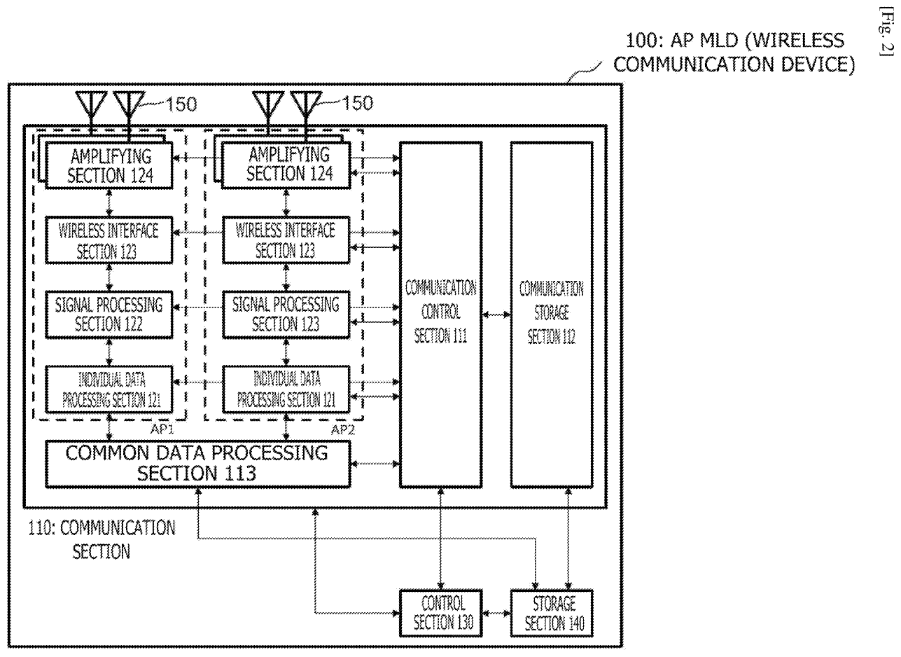

FIG. 2 is a block diagram of the AP MLD 100 including a wireless communication control device according to the embodiment of the present disclosure.

Broadly speaking, the AP MLD 100 includes a communication section 110, a control section 130, and a storage section 140. The communication section 110 includes a communication control section 111, a communication storage section 112, a common data processing section 113, an AP 1, and an AP 2. The communication section 110 can be realized by one or more LSIs.

Each of the AP 1 and the AP 2 includes an individual data processing section 121, a signal processing section 122, a wireless interface section 123, one or more amplifying sections 124, and one or more antennas 150. That is, each AP includes one set of an individual data processing section 121, a signal processing section 122, a wireless interface section 123, amplifying sections 124, and antennas 150, and two or more APs are constituent elements of the wireless communication device 100.

The AP 1 performs processes related to the link 1 in the AP MLD 100, and the AP 2 performs processes related to the link 2 in the AP MLD 100. In particular, the set of the individual data processing section 121 and the signal processing section 122 in each AP is also referred to as an AP entity. Each AP implements communication on the respective links.

The AP 1 or its AP entity corresponds to a first wireless communication section that performs communication related to the link 1 (first communication), and the AP 2 or its AP entity corresponds to a second wireless communication section that performs communication related to the link 2 (second wireless).

The communication control section 111 controls operations of each section and information transfer between the respective sections. In addition, the communication control section 111 controls delivery of control information and management information to be given to other wireless communication devices to the common data processing section 113, the AP 1, and the AP 2. The communication control section 111 is also referred to as an MLD management entity.

In the present embodiment, in particular, each section is controlled such that, in at least a part of a period during which the first communication is being performed with a fourth wireless communication device in a plurality of first wireless communication devices (the Non-AP MLDs 1/2), schedule information which is information specifying a schedule related to the second communication of a third wireless communication device which is at least one of the plurality of first wireless communication devices is transmitted to the fourth wireless communication device through the second communication. The operating fourth wireless communication device may be the same as the third wireless communication device. For example, it is assumed that the fourth wireless communication device is the Non-AP MLD 2, and the third wireless communication device also is the Non-AP MLD 2. In this case, for example, in a period during which data is being transmitted to the Non-AP MLD 2 through the first communication, simultaneously, schedule information (e.g., Power Save information or information regarding TWT) about the second communication with the Non-AP MLD 2 is transmitted to the Non-AP MLD 2 through the second communication.

In addition, the communication control section 111 controls each section such that, in a case where a retransmission request for the schedule information is received from the fourth wireless communication device through the first communication after the schedule information is transmitted, the schedule information is transmitted (retransmitted) to the fourth wireless communication device through the first communication and/or the second communication.

The communication storage section 112 retains information to be used at the communication control section 111. In addition, the communication storage section 112 retains data to be transmitted to the Non-AP MLDs 1/2 and data received from the Non-AP MLDs 1/2.

At the time of transmission, the common data processing section 113 performs sequence management of data retained in the communication storage section 112 and control information and management information received from the communication control section 111, performs an encryption process or the like, and allocates the data after the processing to each individual data processing section 121. At the time of reception, the common data processing section 113 performs a data decryption process and reordering process.

At the time of transmission, each individual data processing section 121 performs a channel access operation according to career sensing, generation of data units by addition of MAC (Media Access Control) headers and addition of error detection codes to data to be transmitted, and a multiple-concatenation process of the data units. At the time of reception, each individual data processing section 121 performs a deconcatenation process on MAC headers of received data units, analysis and error detection, and a retransmission request operation.

Note that operations of the common data processing section 113 and each individual data processing section 121 are not limited to the operations mentioned above, and, for example, one of them can perform an operation of the other in some cases. The common data processing section 113 is referred to as an Upper MAC, a Higher MAC, or an MLD entity, and the individual data processing section 121 is also referred to as a Lower MAC.

At the time of transmission, each signal processing section 122 performs encoding, interleaving, modulation, or the like on data units, adds physical headers, and generates a symbol stream. At this time, each signal processing section 122 may perform a spatial separation process for MIMO (Multi Input Multi Output). It should be noted that each signal processing section 122 may not perform a spatial separation process, but a certain delay (hereinafter, cyclic shift delay; CSD: Cyclic Shift Delay) may be applied for each antenna 150. At the time of reception, each signal processing section 122 analyzes physical headers, performs demodulation, de-interleaving, decoding, or the like on a symbol stream, and generates data units. In addition, each signal processing section 122 performs complex-channel-characteristics estimation and a spatial separation process, as necessary.

At the time of transmission, each wireless interface section 123 performs digital-analog signal conversion, filtering, up-conversion, and phase control on a symbol stream, and generates a transmission signal. At the time of reception, the wireless interface section 123 performs down-conversion, filtering, and analog-digital signal conversion on a reception signal, and generates a symbol stream.

The amplifying sections 124 of each AP amplify signals input from the wireless interface section 123 or the antenna 150. The amplifying sections 124 may be partially constituent elements outside the communication section 110. In addition, the amplifying sections 124 may be partially incorporated into the wireless interface section 123.

The control section 130 controls the communication section 110 and the communication control section 111. In addition, the control section 130 may instead perform some of operations of the communication control section 111. In addition, the communication control section 111 and the control section 130 may be configured as one block. As an example, the control section of the wireless communication control device according to the embodiment of the present disclosure corresponds to the communication control section 111 or corresponds to at least one of the communication section 110 and the communication control section 111. In addition, as an example, the wireless communication control device according to the embodiment of the present disclosure may include the communication control section 111 and may include other constituent elements, for example at least one of the AP 1 and the AP 2.

The storage section 140 retains information to be used at the control section 130 and the communication section 110. In addition, the storage section 140 may instead perform some of operations of the communication storage section 112. The storage section 140 and the communication storage section 112 may be configured as one block.

In addition, each AP may include a storage section. Note that, whereas the frequency (or frequency band) of a link used by each AP is different from that of another AP in the present embodiment, this does not preclude a case where the APs use the same frequency (or frequency band).

An individual data processing section 121 and a signal processing section 122 may be treated as one set, and a plurality of the sets may be connected with one wireless interface section 123, in another possible manner of configuration. That is, a plurality of APs may share the one wireless interface section 123.

In addition, a wireless interface section 123, an amplifying section 124, and an antenna 150 may be treated as one set, and a plurality of the sets may be connected with one signal processing section 122, in another possible manner of configuration. That is, a plurality of APs may share the signal processing section 122. In this case, there may be one individual data processing section 121 or a plurality of individual data processing sections 121.

### Configuration Example of Non-AP MLDs 1/2

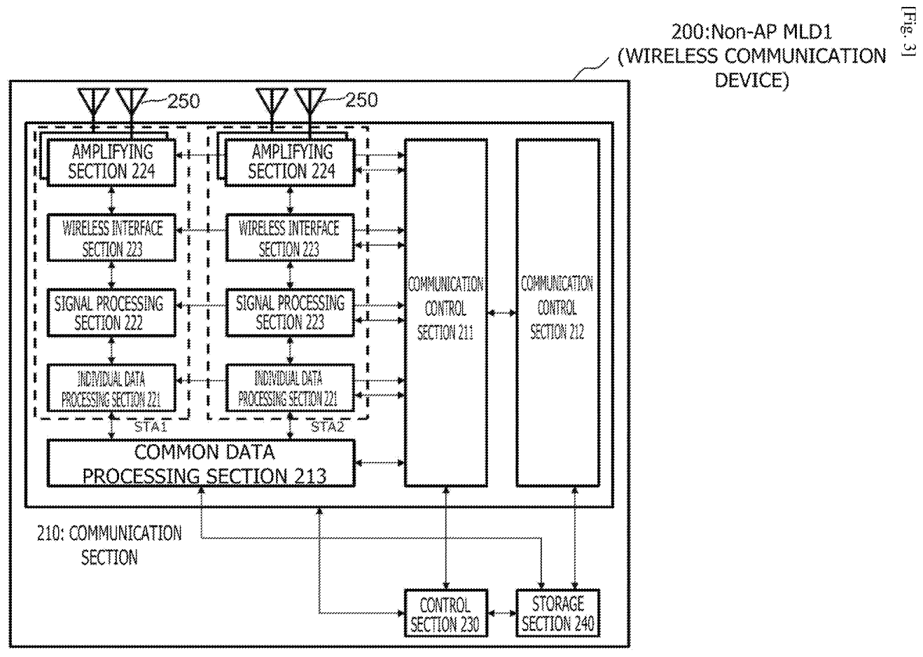

FIG. 3 is a block diagram of the Non-AP MLD 1 including a wireless communication control device according to the embodiment of the present disclosure. The basic configuration of the Non-AP MLD 1 is similar to that of the AP MLD 100. In addition, since the configuration of the Non-AP MLD 2 is similar to that of the Non-AP MLD 1, the explanation about the Non-AP MLD 1 serves also as the explanation about the Non-AP MLD 2.

Broadly speaking, the Non-AP MLD 1 includes a communication section 210, a control section 230, and a storage section 240. The communication section 210 includes a communication control section 211, a communication storage section 212, a common data processing section 213, a Non-AP STA 1 (hereinafter, an STA 1) and a Non-AP STA 2 (hereinafter, an STA 2). The communication section 210 can be realized by one or more LSIs.

Each of the STA 1 and the STA 2 includes an individual data processing section 221, a signal processing section 222, a wireless interface section 223, one or more amplifying sections 224 and one or more antennas 250. That is, each Non-AP (STA) is configured by using one set of an individual data processing section 221, a signal processing section 222, a wireless interface section 223, amplifying sections 224, and antennas 250, and two or more Non-APs (STAs) are constituent elements of the wireless communication device 100.

The STA 1 performs processes related to the link 1 in the Non-AP MLD 1, and the STA 2 performs processes related to the link 2 in the Non-AP MLD 1. In particular, the set of the individual data processing section 221 and the signal processing section 222 is also referred to as a non-AP STA entity. The STA 1 or its non-AP STA entity corresponds to the first wireless communication section that performs communication related to the link 1 (first communication), and the STA 2 or its non-AP entity corresponds to the second wireless communication section that performs communication (second communication) related to the link 2.

The communication control section 211 controls operations of each section and information transfer between the respective sections. In addition, the communication control section 211 controls delivery of control information and management information to be given to other wireless communication devices to the common data processing section 213, the STA 1, and the STA 2. The communication control section 211 is also referred to as an MLD management entity.

In the present embodiment, in particular, for example, the communication control section 211 controls each section such that, in a case where reception of schedule information has failed at the STA 2 in at least a part of a period during which communication (first communication) on the first link with the AP MLD 100 is being performed by the STA 1 (first wireless communication section), the STA 1 (first wireless communication section) transmits a retransmission request for the schedule information through the first communication. In addition, the communication control section 211 controls each section such that, in a case where at least one of the STA 1 (first wireless communication section) and the STA 2 (second wireless communication section) has received the schedule information through at least one of the first communication and the second communication after the retransmission request is transmitted, operations according to the received schedule information are performed.

The communication storage section 212 retains information to be used at the communication control section 211. In addition, the communication storage section 212 retains data to be transmitted to the AP MLD 100 and data received from the AP MLD 100.

At the time of transmission, the common data processing section 213 performs sequence management of data retained in the communication storage section 212 and control information and management information received from the communication control section 211, performs an encryption process or the like, and allocates the data after the processing to each individual data processing section 221. At the time of reception, the common data processing section 213 performs a data decryption process and a reordering process.

At the time of transmission, each individual data processing section 221 performs a channel access operation according to career sensing, generation of data units by addition of MAC (Media Access Control) headers and addition of error detection codes to data to be transmitted, and a multiple-concatenation process of the data units. At the time of reception, each individual data processing section 221 performs a deconcatenation process on MAC headers of received data units, analysis and error detection, and a retransmission request operation.

Note that operations of the common data processing section 213 and each individual data processing section 221 are not limited to the operations mentioned above, and, for example, one of them can perform an operation of the other in some cases. The common data processing section 213 is referred to as an Upper MAC, a Higher MAC, or an MLD entity, and the individual data processing section 221 is also referred to as a Lower MAC.

At the time of transmission, each signal processing section 222 performs encoding, interleaving, modulation, or the like on data units, adds physical headers, and generates a symbol stream. At this time, each signal processing section 222 may perform a spatial separation process for MIMO. It should be noted that each signal processing section 222 may not perform a spatial separation process, but a certain delay (hereinafter, cyclic shift delay; CSD: Cyclic Shift Delay) may be applied for each antenna 250. At the time of reception, each signal processing section 222 analyzes physical headers, performs demodulation, de-interleaving, decoding, or the like on a symbol stream, and generates data units. In addition, each signal processing section 222 performs complex-channel-characteristics estimation and a spatial separation process, as necessary.

At the time of transmission, each wireless interface section 223 performs digital-analog signal conversion, filtering, up-conversion, and phase control on a symbol stream, and generates a transmission signal. At the time of reception, the wireless interface section 223 performs down-conversion, filtering, and analog-digital signal conversion on a reception signal, and generates a symbol stream.

The amplifying sections 224 of each Non-AP amplify signals input from the wireless interface section 223 or the antenna 250. The amplifying sections 224 may be partially constituent elements outside the communication section 210. In addition, the amplifying sections 224 may be partially incorporated into the wireless interface section 223.

The control section 230 controls the communication section 210 and the communication control section 211. In addition, the control section 230 may instead perform some of operations of the communication control section 211. In addition, the communication control section 211 and the control section 230 may be configured as one block. As an example, the control section of the wireless communication control device according to the embodiment of the present disclosure corresponds to the communication control section 211 or corresponds to at least one of the communication section 210 and the communication control section 211. In addition, as an example, the wireless communication control device according to the embodiment of the present disclosure may include the communication control section 211 and may include other constituent elements, for example at least one of the STA 1 and the STA 2.

The storage section 240 retains information to be used at the control section 230 and the communication section 210. In addition, the storage section 240 may instead perform some of operations of the communication storage section 212. The storage section 240 and the communication storage section 212 may be configured as one block.

In addition, each Non-AP may include a storage section. Note that, whereas the frequency (or frequency band) of a link used by each Non-AP is different from that of another Non-AP in the present embodiment, this does not preclude a case where the APs use the same frequency (or frequency band).

An individual data processing section 221 and a signal processing section 222 may be treated as one set, and a plurality of the sets may be connected with one wireless interface section 223, in another possible manner of configuration. That is, a plurality of Non-APs may share the one wireless interface section 223.

In addition, a wireless interface section 223, an amplifying section 224, and an antenna 250 may be treated as one set, and a plurality of the sets may be connected with one signal processing section 222, in another possible manner of configuration.

That is, a plurality of APs may share the signal processing section 222. In this case, there may be one individual data processing section 221 or a plurality of individual data processing sections 221.

### Operation Example of AP MLD 100 and Non-AP MLDs 1/2 in Present Embodiment

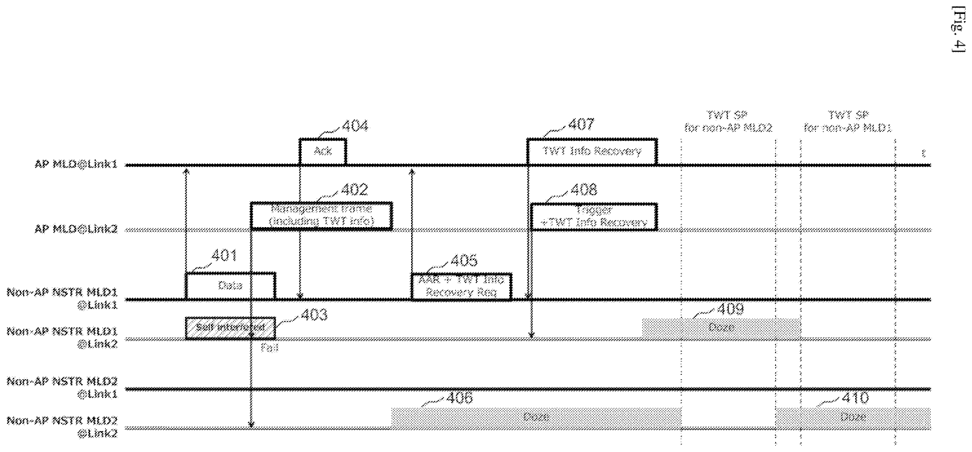

FIG. 4 is a sequence diagram depicting an example of operations of the AP MLD 100 and the non-AP MLDs 1/2. Sequences of the AP MLD 100 and the non-AP MLDs 1/2 on the link 1 are denoted by @Link1, and are depicted along solid-line time axes. Similarly, sequences of the AP MLD and the non-AP MLDs 1/2 on the link 2 are denoted by @Link2, and are depicted along double-line time axes. There may be an appropriate frame interval according to an IEEE802.11 standard between frames transmitted and received between the AP MLD 100 and the non-AP MLDs 1/2. Examples of the types of frame interval include SIFS (short interframe space), DIFS (distributed coordination function interframe space), AIFS (arbitration interframe space), PIFS (point coordination function interframe space), EIFS (extended interframe space), RIFS (reduced interframe space), and the like.

Before the start of these sequences, the AP MLD 100 and the non-AP MLDs 1/2 may exchange Capability information for checking whether they support functions of the present embodiment.

First, the Non-AP MLD 1 is transmitting a data signal 401 to the AP MLD 100 on the link 1, for example. Whereas the Non-AP MLD 1 is performing transmission here, there can also be a case where the Non-AP MLD 1 is performing reception. The AP MLD 100 may transmit an Ack 404 to Non-AP NSTR MLD1 on link 1 .E

While the Non-AP MLD 1 is transmitting the data signal 401, the AP MLD 100 transmits, on the link 2, a signal 402 including schedule information regarding subsequent communication on the link 2 to a plurality of Non-AP MLDs including the Non-AP MLD 1 and the Non-AP MLD 2 (S402). The signal 402 is transmitted in a management frame in the present example. The schedule information may be information regarding a power saving operation of at least one of subordinate Non-AP MLDs. In this case, examples of the information regarding a power saving operation may include a period of a Doze state, and a period which is after returning from the Doze state and during which signal transmission and reception are performed. In addition, the schedule information may include types or priorities of signals to be transmitted, and information regarding designation of wireless communication devices to perform transmission. In addition, the information regarding a power saving operation may be information regarding Target Wake Time (TWT) or Restricted TWT specified in IEEE 802.11. Details of TWT are described in IEEE Std 802.11-2020 10.47. As a modification example, the signal 402 may include schedule information regarding subsequent communication related to the link 1.

Since the Non-AP MLD 1 is an NSTR MLD, the transmission of the data signal 401 causes self-interference with the wireless communication section (STA 2) of itself operating on the link 2 (S403)E. Because of this, the Non-AP MLD 1 fails to demodulate the signal 402 (management frame) on the link 2. On the other hand, the Non-AP MLD 2 is an NSTR MLD, but since the Non-AP MLD 2 is not performing a transmission operation, self-interference does not occur, and the Non-AP MLD 2 can correctly demodulate the signal 402.

The Non-AP MLD 2 having correctly demodulated the signal 402, and acquired the schedule information identifies periods during which it needs to be kept activated (TWT SP for Non-AP MLD 2) and periods during which it does not need to be kept activated, and transitions to Doze states 406 and 410 in the periods during which it does not need to be kept activated.

The Non-AP MLD 1 that has failed to demodulate the signal of 402 on the link 2 determines that there is a possibility that it has failed to acquire the schedule information. In addition, the Non-AP MLD 100 loses (media information) regarding the use status of a wireless medium, for example, NAV information set by the AP MLD 100. If the NAV information is lost, it becomes impossible for the Non-AP MLD 1 to grasp periods during which access to the wireless medium is prohibited, and the like.

Because of this, the Non-AP MLD 1 determines that it is necessary to promptly acquire (recover) the media information.

The Non-AP MLD 1 transmits, to the AP MLD 100 on the link 1 on which media information is not lost, a signal 405 including a recovery request for the schedule information (TWT info Recovery Req) and a recovery request for the media information (AP Assisted Recovery (AAR) Req). The signal 405 may be a signal including an AP Assisted Recovery (AAR) Control Subfield specified in IEEE 802.11. The format of the signal 405 is mentioned later.

The AP MLD 100 having received the signal 405 on the link 1 transmits a signal 407 for recovering the schedule information for the Non-AP MLD 1 on the link 1. The signal 407 includes the recovered schedule information. The recovered schedule information can include either a schedule which is the same as the schedule information that could not be demodulated on the link 2 initially or an updated schedule which has been updated from the schedule. The signal 407 may be a signal including a TWT element specified in IEEE 802.11. The format of the signal 407 is mentioned later.

In addition, the AP MLD 100 transmits a signal 408 for recovering the schedule information and the media information to the Non-AP MLD 1 on the link 2. The signal includes the recovered schedule information and the recovered media information. For example, the recovered media information includes information regarding a NAV period identified on the basis of the value of a Duration field in a frame including the signal 408. In addition, in a case where there is an instruction, in the frame and to another Non-AP MLD, for transmission in a designated period, the designated period may also be included in the media information. The AP MLD 100 may configure the signal 408 by using a Trigger frame specified in IEEE 802.11. The format of the signal 408 is mentioned later.

The Non-AP MLD 1 having received the signal 407 on the link 1 acquires the recovered schedule information from the signal 407. In addition, the Non-AP MLD 1 having received the signal 408 on the link 2 acquires the recovered schedule information, and also acquires the recovered media information.

Thereafter, the Non-AP MLD 1 operates according to the schedule information acquired from at least one of the signal 407 or the signal 408 on the link 2. In the present example, the Non-AP MLD 1 having acquired the schedule information identifies periods during which it needs to be kept activated (TWT SP for Non-AP MLD 1) and periods during which it does not need to be kept activated, and transitions to a Doze state 409 in a period during which it does not need to be kept activated. According to the recovered media information, the Non-AP MLD 1 can also perform an operation of grasping a period during which it can access a wireless medium, an operation of transmitting a frame that is initiated from itself (transmitted proactively not in response to a frame received from another device), or the like.

Whereas the AP MLD 100 has transmitted the recovered schedule information on both the link 1 and the link 2 in these sequences, the AP MLD 100 may transmit it on only one of the link 1 or the link 2.

In a case where the AP MLD 100 transmits the schedule information on the link 1, it can transmit the schedule information fast as a prompt response to the signal 405 received on the link 1. Accordingly, the Non-AP MLD 1 can notify (retransmit) the schedule information fast. In addition, in a case where the AP MLD 100 notifies the schedule information simultaneously also to a Non-AP MLD other than the Non-AP MLD 1, it can notify the information on the link 1 also to a Non-AP MLD whose link 2 is in a Doze state if the link 1 is in an Awake state.

In addition, in a case where the AP MLD 100 transmits the schedule information on the link 2 and notifies the recovered schedule information simultaneously also to a Non-AP MLD other than the Non-AP MLD 1, it can notify the schedule information on the link 2 also to a Non-AP MLD whose link 1 is in a Doze state if the link 2 is in an Awake state.

Whereas the Non-AP MLD 1 transmits, on the link 1, the signal 405 including the request for the recovery of the schedule information and also the request for the recovery of the media information in these sequences, the AP MLD 100 may transmit a signal including only the request for the recovery of the schedule information. In this case also, if the format of a frame including the recovered schedule information is a format including the media information (e.g., a format including a Duration field), reception of the frame in the format results in the recovery of the media information. In addition, even if the format of the frame including the recovered schedule information is a format not including the media information (e.g., a frame in a format not including a Duration field), by receiving a frame including the media information as time elapses, the media information is recovered at that time. Accordingly, although there is a possibility that the recovery of the media information is delayed, problems in terms of operations will not occur.

### Frame Format

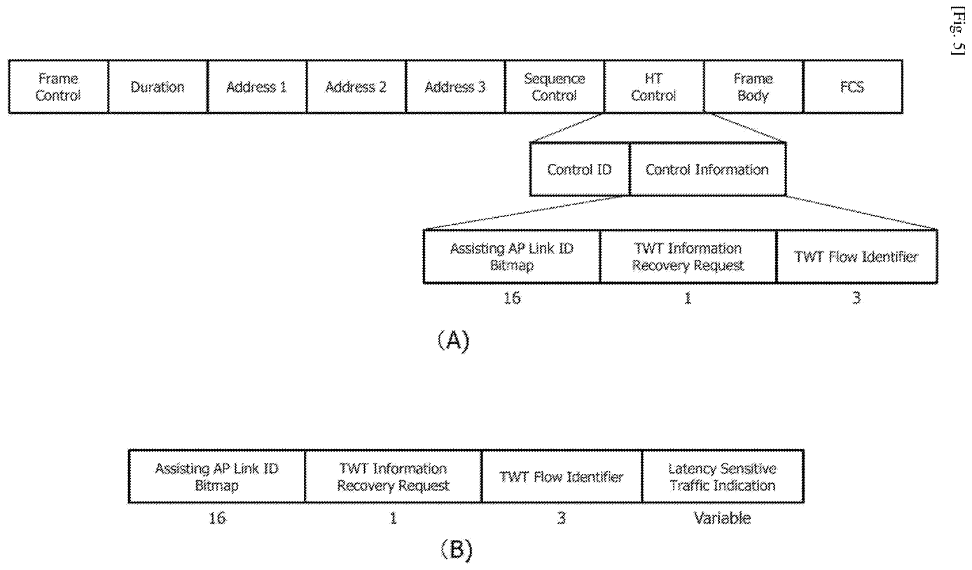

FIG. 5 depicts frame formats of the signal 405 including the retransmission request for the schedule information and a request for an operation related to the recovery of the media information. A frame in FIG. 5 includes Frame Control, Duration, Address 1, Address 2, Address 3, Sequence Control, Frame Body, and FCS, as a plurality of fields.

Frame Control includes information regarding the type of the frame, Duration includes the length of the frame, Addresses 1, 2, and 3 include information regarding sender/recipient addresses, Sequence Control includes information regarding the sequence number of the frame, Frame Body includes data body, and FCS includes information regarding error detection. In the present embodiment, Frame Body may be empty (QOS Null). HT Control includes A-Control of EHT (Extremely High Throughput) Variant, and A-Control includes Control ID and Control Information.

Control ID includes information representing that the signal 405 is a signal including the retransmission request for the schedule information and the request for the operation related to the recovery of the media information. Control Information includes Assisting AP Link ID Bitmap, TWT Information Recovery Request, and TWT Flow Identifier.

Assisting AP Link ID Bitmap includes information that identifies a link for which the recovery of the media information is necessary. TWT Information Recovery Request includes information representing the retransmission request for the schedule information (TWT information). TWT Flow Identifier includes information representing Flow ID of TWT for which the retransmission request is made. Flow ID of TWT is an ID that identifies a plurality of groups of wireless communication devices (or wireless communication sections) related to a power saving operation. Multiple Non-AP MLDs including the Non-AP MLD 1 and the Non-AP MLD 2 which are subordinate to the AP MLD 100 belong to any groups as a result of preliminary negotiations with the AP MLD 100. Note that there is an independent group for each link, and, for example, in a case of the link 2, the STAs 2 of the multiple Non-AP MLDs are grouped. The same applies also to the link 1, and the STAs 1 of the multiple Non-AP MLDs may be grouped.

Note that these fields may be realized on the basis of AAR Control specified in IEEE 802.11, and in particular, may be realized by allocating TWT Information Recovery Request and TWT Flow Identifier to Reserve of AAR Control.

In addition, as depicted in FIG. 5(B), Control Information may additionally include Latency Sensitive Traffic Indication, in another possible manner of configuration. Latency Sensitive Traffic Indication includes information representing that the Non-AP MLD 1 that transmits the signal 405 retains information that needs to be transmitted with short delays. As a result, on the basis of the information, the AP MLD 100 having received the signal 405 can update TWT information (update the schedule information) so as to prioritize transmission by the Non-AP MLD 1, for example. For example, in a case where Latency Sensitive Traffic Indication includes information representing that the Non-AP MLD 1 retains information that needs to be transmitted with short delays, intervals at which the Non-AP MLD 1 transitions to Awake states on the link 2 may be shortened.

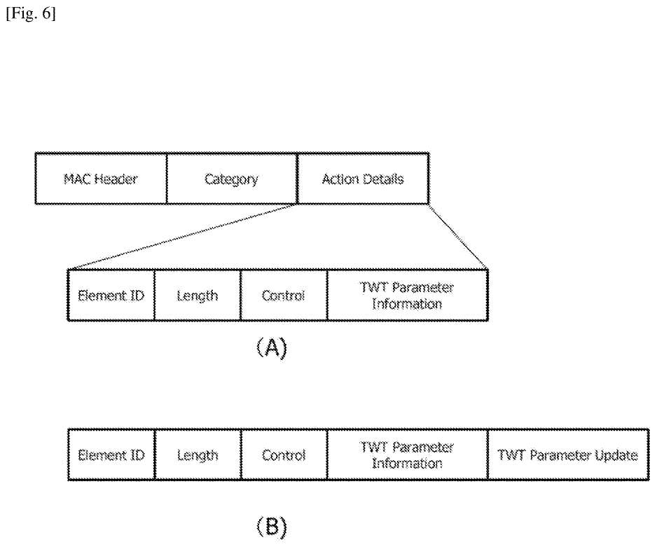

FIG. 6(A) depicts a frame format example of the signal 407 including the schedule information transmitted by the AP MLD 100 to the Non-AP MLD 1 on the link 1. A frame in FIG. 6(A) is also referred to as a TWT Information Recovery Action frame. The frame in FIG. 6 includes MAC Header, Category, and Action Details as a plurality of fields. FCS may be provided after Action Details.

This frame may be transmitted only to the Non-AP MLD 1 (STA 1) or may be transmitted to a plurality of wireless communication devices including the Non-AP MLD 1 (STA 1). MAC Header includes header information, and Category includes information regarding the type of the frame.

Action Details include Element ID, Length, Control, and TWT Parameter Information. Element ID includes information regarding the type of an element, Length includes information regarding the length of the element, and Control and TWT Parameter Information include information regarding settings of TWT. This frame and TWT Parameter Information may be an Action frame and a TWT element specified in IEEE 802.11.

In addition, as depicted in FIG. 6(B), Action Details may additionally include TWT Parameter Update. TWT Parameter Update includes information representing that settings of TWT being given have been updated from settings of TWT that was given before (that the schedule information has been updated).

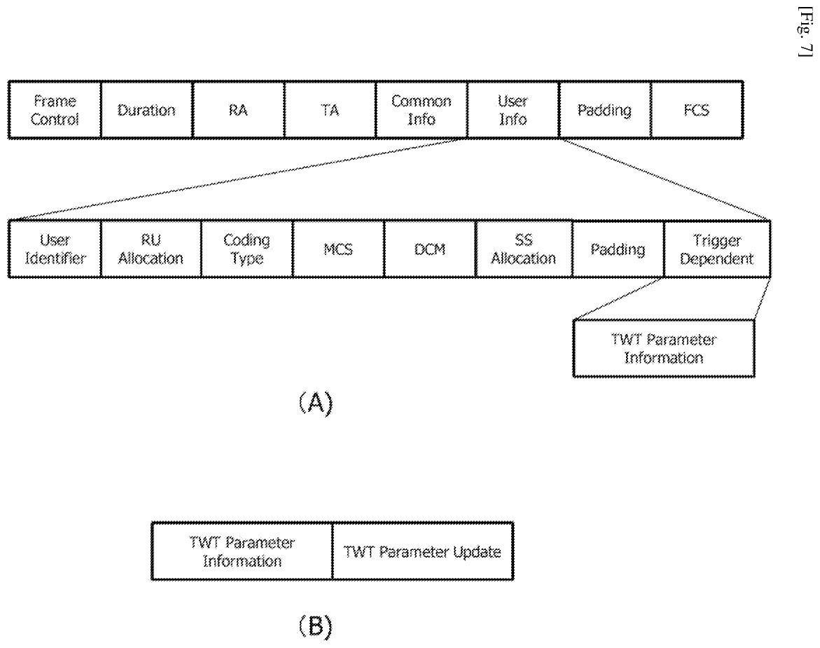

FIG. 7(A) depicts a frame format example of the signal 408 for the AP MLD 100 to recover the schedule information and also to recover the media information for the Non-AP MLD 1 on the link 2. This format corresponds to the format of a Trigger frame specified in IEEE 802.11. The frame in FIG. 7(A) includes Frame Control, Duration, RA, TA, Common Info, Padding, and FCS as a plurality of fields.

Frame Control includes information regarding the type of the frame, Duration includes information regarding the length of the frame, RA includes information regarding recipient addresses, TA includes information regarding a sender address, Common Info includes information that is common to the whole of destination terminals, Padding includes information regarding an adjustment of the length of the frame, and FCS includes information regarding error detection.

User Info includes User Identifier, RU Allocation, Coding Type, MCS, DCS, SS Allocation, Padding, and Trigger Dependent. User Identifier includes information regarding individual destinations. RU Allocation, Coding Type, DCM, MCS, and SS Allocation include pieces of information regarding a frequency resource, coding, Modulation and Coding Scheme (MCS), Dual Carrier Modulation (DCM), and a spatial resource to be used when making a response, respectively. Padding includes information regarding an adjustment of the length.

Trigger Dependent includes information according to the use of the Trigger frame, and, in the present example, includes schedule information. For example, TWT Parameter Information depicted in FIG. 6(A) may be included. In addition, as in FIG. 6(B), TWT Parameter Update may be additionally included as depicted in FIG. 7(B).

In addition, in a case where the signal 408 is only for the purpose of notifying the schedule information, and does not require a response, necessary information is set only for User Identifier and Trigger Dependent in User Info, and other fields may be left blank or removed.

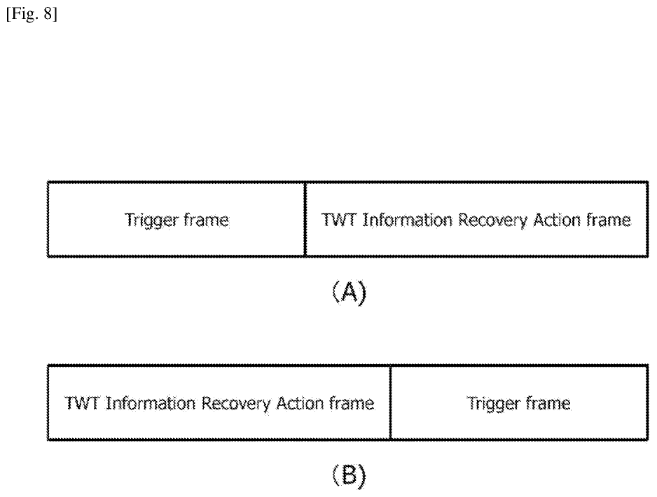

Each of FIG. 8(A) and FIG. 8(B) depicts another frame format example of the signal 408 for recovering the schedule information and also for recovering the media information for the Non-AP MLD 1 on the link 2.

Both the frames in the formats in FIG. 8(A) and FIG. 8(B) are realized by A-MPDU formed by concatenating a Trigger frame specified in IEEE 802.11 and the frame (TWT Information Recovery Action frame) depicted in FIG. 6(A). Examples of the use of the Trigger frame in this case may include causing one or more wireless communication devices to execute UL-MU-MIMO (Uplink Multi-User Multiple Input Multiple Output) or UL-OFDMA (Uplink Orthogonal Frequency Division Multiple Access). The difference between the frames in FIG. 8(A) and in FIG. 8(B) lies in the order of concatenation of the Trigger frame and the TWT Information Recovery Action frame.

In FIG. 8(A), the Trigger frame is concatenated on the head side. As a result, a destination wireless communication device can promptly grasp the content of the Trigger frame and promptly perform a preparation for a response.

In FIG. 8(B), the TWT Information Recovery Action frame is concatenated on the head side. As a result, in a case where a response is unnecessary, a destination wireless communication device can promptly grasp the schedule information.

The order of concatenation may be selected by the communication control section 111 of the AP MLD 100. For example, in a case where the communication control section 111 of the AP MLD 100 prioritizes a request for a response to the Trigger frame, the Trigger frame is concatenated on the head side. In a case where the communication control section 111 of the AP MLD 100 does not prioritize or request a response to the Trigger frame or prioritizes notification of the schedule information, the TWT Information Recovery Action frame is concatenated on the head side.

Frames to be concatenated to the TWT Information Recovery Action frame are not limited to the Trigger frame. For example, a data frame, an RTS (Request To Send) frame, or the like whose destination is a certain wireless communication device may be concatenated. In addition, the Trigger frame may be Trigger frame for Random Access.

In the present embodiment, in a case where a failure of reception of a signal on the second link is detected during transmission of a data signal on the first link, the signal 405 including the retransmission request for the schedule information is transmitted because there is a possibility that reception of the schedule information has failed. However, there can be also a case where information that has actually failed to be received is not the schedule information. In this case, the AP MLD 100 may transmit (retransmit) the latest schedule information that has been received by the Non-AP MLD 1 or may transmit updated schedule information in a case where the schedule has been updated. Alternatively, the AP MLD 100 may transmit information representing that there is no schedule information that should be transmitted.

Whereas the present embodiment has depicted an operation example in a case where reception of a signal on the second link has failed during transmission of a data signal on the first link, similar operations are possible also in a case where reception on the second link has failed during reception of a data signal on the first link.

In addition, whereas the present embodiment has depicted an operation example in a case where reception of a signal on the second link has failed, an operation of transmitting the retransmission request for the schedule information on the second link may be performed in a case where a failure of reception of a signal on the first link is detected during transmission or reception on the second link. In this case also, sequences similar to the sequences in FIG. 4 are possible, except that the operations on the first link and the operations on the second link are replaced with each other.

According to the present embodiment having explained thus far, even in a case where an NSTR MLD has failed to receive schedule information (e.g., schedule information regarding a power saving operation) about communication on the link 2 due to intra-device interference, the NSTR MLD can promptly acquire the schedule information by transmitting a retransmission request for the schedule on the link 1. As a result, in a case where the schedule information is schedule information for the NSTR MLD itself (e.g., schedule information regarding a power saving operation), the NSTR MLD can promptly perform an appropriate operation (e.g., transition to a power saving state). In addition, also in a case where the schedule information is information instructing another wireless communication device to transition to a power saving state, it is possible to reduce the likelihood that unnecessary communication is performed with the wireless communication device having transitioned to the power saving state, by promptly acquiring information having failed to be received. In this manner, it is possible to prevent an NSTR MLD from performing unexpected communication, and to reduce the likelihood that the NSTR MLD inhibits other communication. In addition, it is possible to suppress an increase of the electric power consumption by reducing the likelihood that the NSTR MLD performs unnecessary communication.

Whereas information regarding TWT is depicted as schedule information and an operation related to TWT is depicted as an operation according to a schedule in the example above, other examples are depicted as modification examples below.

### First Modification Example

An operation related to a schedule of communication may be an operation of allowing a particular wireless communication device (an AP MLD or a Non-AP MLD) to perform communication preferentially or exclusively. In this case, this communication may be communication between an AP MLD and a Non-AP MLD or may be P2P (Peer to Peer) communication between Non-AP MLDs. In this case, for example, a retransmission request and retransmitted schedule information include identifiers of wireless communication devices that are allowed to perform communication preferentially or exclusively on the link 2 and information regarding its communication period. In this communication period, for example, communication between the AP MLD 100 and the Non-AP MLD 1 is performed on the link 2 or P2P communication between the Non-AP MLDs 1/2 is performed in a frequency band of the link 2. In a case of P2P communication, communication with the AP MLD 100 on the link 2 may be prohibited.

The communication period may be defined as a time interval having its start point at a time point at which the frame of the signal 408 is received or may be defined as a time interval having its start point at a transmission timing of a beacon signal periodically transmitted from the AP MLD 100. That is, the communication period may be designated by a position in a beacon interval. NSTR MLDs (e.g., the Non-AP MLDs 1/2) having acquired the schedule information operate appropriately on the basis of the acquired schedule information. For example, in a case where the schedule represents that an NSTR MLD performs communication preferentially or exclusively, the NSTR MLD performs communication in a designated communication period, and in a case where the schedule represents that another device performs communication preferentially or exclusively, the NSTR MLD avoids communication in a designated

### Second Modification Example

An operation related to a schedule of communication may be an operation of allowing the AP MLD 100 to perform communication preferentially or exclusively with AP MLDs selected from other AP MLDs in cooperation with those other AP MLDs. Allowing selected AP MLDs to perform communication preferentially or exclusively means that an AP MLD cooperatively selected from a plurality of AP MLDs whose coverage at least partially overlaps is treated as a particular AP MLD, and the particular AP MLD and a wireless communication device (Non-AP MLD) group belonging to the BSS of the particular AP MLD can perform communication preferentially or exclusively over other AP MLDs other than the particular AP MLD.

In this case, a retransmission request and retransmitted schedule information include identifiers of the particular AP MLD described above or the BSS (Basic Service Set) of the particular AP MLD, and a communication period. The communication period may be a period defined as having its start point at a time point at which the frame of the signal 408 is received or may be a period defined as having its start point at a transmission timing of a beacon signal periodically transmitted from the AP MLD 100.

In this communication period, for example, communication in the BSS represented by the schedule information is performed preferentially or exclusively. An NSTR MLD having acquired the schedule information operates on the basis of the acquired information. For example, in a case where the NSTR MLD belongs to the BSS, the NSTR MLD can communicate with the AP MLD in the designated communication period, and in a case where the NSTR MLD does not belong to the BSS, the NSTR MLD avoids communication with the AP MLD in the designated communication period.

### Third Modification Example

An operation related to a schedule of communication may be a Sounding operation for MIMO (Multi Input Multi Output) training. In this case, for example, a re-transmission request and retransmitted schedule information include an identifier of Sounding and information regarding its Sounding period.

The Sounding period may be a period defined as having its start point at a time point at which the frame of the signal 408 is received or may be a period defined as having its start point at a transmission timing of a beacon signal periodically transmitted from the AP MLD 100.

In the Sounding period, a Sounding operation for MIMO training is performed. An NSTR MLD (e.g., the Non-AP MLDs 1) having acquired the schedule information operates on the basis of the acquired information. For example, in a case where the schedule information represents that the NSTR MLD performs Sounding, the NSTR MLD performs communication in the designated Sounding period, and in a case where the schedule information represents that another device performs Sounding, the NSTR MLD avoids communication in the designated Sounding period.

### Fourth Modification Example

An operation related to a schedule of communication may be a measurement operation for position estimation. In this case, for example, a retransmission request and a retransmitted schedule information include information regarding a measurement operation period. The measurement operation period may be a period defined as having its start point at a time point at which the frame of the signal 408 is received or may be a period defined as having its start point at a transmission timing of a beacon signal periodically transmitted from the AP MLD 100.

In this measurement operation period, a measurement operation such as transmission of a signal for position estimation and detection of a signal as a response to the transmitted signal or static signal detection (e.g., detection of signals from a device such as a satellite that transmits signals regularly) is performed. Communication with the AP MLD 100 may be prohibited in this period.

An NSTR MLD having acquired the schedule information operates on the basis of the acquired information. For example, in a case where the schedule information represents that the NSTR MLD performs a measurement operation, the NSTR MLD performs communication, and in a case where the schedule information represents that another device performs a measurement operation, the NSTR MLD avoids communication.

### <<Configuration Example of Computer>>

The series of processing mentioned above can also be executed by hardware or can also be executed by software. In a case where the series of processing is executed by software, a program included in the software is installed on a computer incorporated into dedicated hardware, a general-purpose personal computer, or the like from a program recording medium.

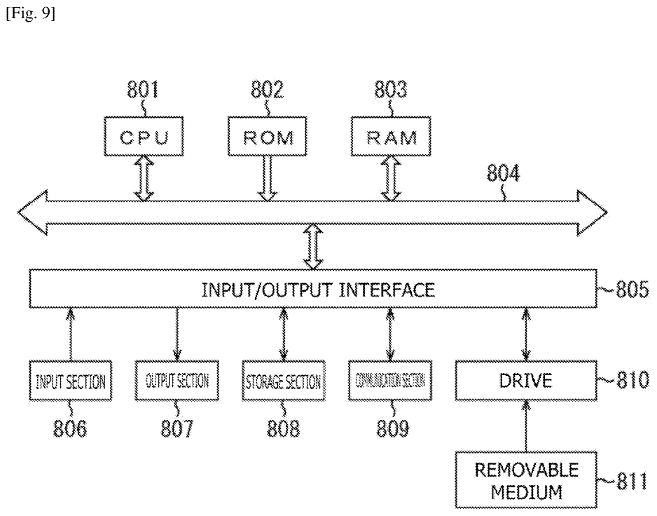

FIG. 9 is a block diagram depicting a configuration example of hardware of a computer that executes the series of processing mentioned above according to a program.

A CPU (Central Processing Unit) 801, a ROM (Read Only Memory) 802, and a RAM (Random Access Memory) 803 are interconnected by a bus 804.

The bus 804 is further connected with an input/output interface 805. The input/output interface 805 is connected with an input section 806 including a keyboard, a mouse, and the like, and an output section 807 including a display, a speaker, and the like. In addition, the input/output interface 805 is connected with a storage section 808 including a hard disk, a non-volatile memory, and the like, a communication section 809 including a network interface and the like, and a drive 810 that drives a removable medium 811.

In the thus-configured computer, for example, the CPU 801 performs the series of processing mentioned above by loading a program stored on the storage section 808 via the input/output interface 805 and the bus 804 onto the RAM 803, and executing the program.

For example, the program executed by the CPU 801 is provided being recorded on the removable medium 811 or provided via a cable or wireless transfer medium like a local area network, the Internet, or digital broadcasting, and installed on the storage section 808.

Note that the program executed by the computer may be a program that performs processes in a temporal sequence along the order explained in the present specification or may be a program that performs processes in parallel or at necessary timings such as timings when the processes are called.

### <<Application Example>>

The present technology can be applied to various products. For example, the wireless communication device 100 in FIG. 2 and the wireless communication device 200 in FIG. 3 may be realized as mobile terminals such as smartphones, tablet PCs (Personal Computers), laptop PCs, portable game terminals, or digital cameras, stationary terminals such as television receivers, printers, digital scanners, or network storages, or vehicle-mounted terminals such as car navigation devices. In addition, the wireless communication device 100 and the wireless communication device 200 may be realized as M2M (Machine To Machine Communication) terminals such as smart meters, vending machines, remote monitoring devices, or POS (Point Of Sale) terminals. Further, the wireless communication device 100 and the wireless communication device 200 may be wireless communication modules (e.g., integrated circuit modules each including one die) mounted on these terminals.

On the other hand, for example, the wireless communication device 100 and the wireless communication device 200 may be realized as APs (wireless base stations) of a wireless LAN having router functions or not having router functions. In addition, the wireless communication device 100 and the wireless communication device 200 may be realized as mobile wireless LAN routers. Further, the wireless communication device 100 and the wireless communication device 200 may be wireless communication modules (e.g., integrated circuit modules each including one die) mounted on these devices.

### <<Configuration Example of Smartphone>>

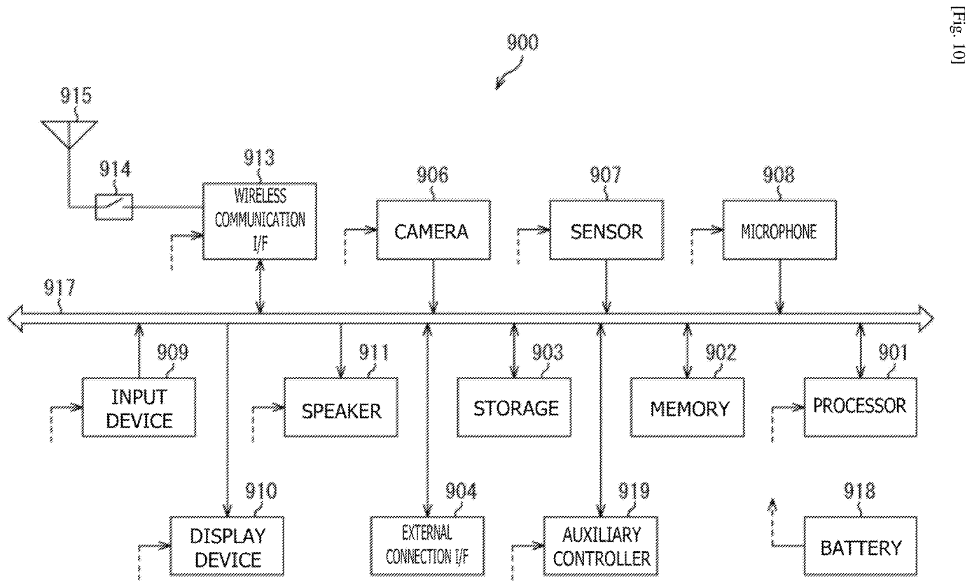

FIG. 10 is a block diagram depicting a schematic configuration example of a smartphone to which the present technology is applied.

A smartphone 900 includes a processor 901, a memory 902, a storage 903, an external connection interface 904, a camera 906, a sensor 907, a microphone 908, an input device 909, and a display device 910. In addition, the smartphone 900 includes a speaker 911, a wireless communication interface 913, an antenna switch 914, an antenna 915, a bus 917, a battery 918, and an auxiliary controller 919.

For example, the processor 901 may be a CPU or a SoC (System on Chip), and restricts functions of the application layer and other layers of the smartphone 900.

The memory 902 includes a RAM and a ROM, and stores programs to be executed by the processor 901 and data.

The storage 903 includes a storage medium such as a semiconductor memory or a hard disk.

The external connection interface 904 is an interface for connecting an externally-attached device such as a memory card or a USB (Universal Serial Bus) device to the smartphone 900.

For example, the camera 906 has an image-capturing element such as a CCD (Charge Coupled Device) or a CMOS (Complementary Metal Oxide Semiconductor), and generates captured images.

For example, the sensor 907 includes a sensor group including a positioning sensor, a gyro sensor, a geomagnetic sensor, an acceleration sensor, and the like.

The microphone 908 converts sounds input to the smartphone 900 into sound signals.

For example, the input device 909 includes a touch sensor that detects a touch on a screen of the display device 910, a keypad, a keyboard, buttons, switches, and the like, and accepts manipulation or information input from a user.

The display device 910 has a screen such as a liquid crystal display (LCD) or an organic light emitting diode (OLED) display, and converts sound signals output from the smartphone 900 into sounds.

The wireless communication interface 913 supports one or more of wireless LAN standards such as IEEE 802.11a, 11b, 11g, 11ac, 11ad, 11ax, 11ay, or 11be, and executes wireless communication.

The wireless communication interface 913 communicates with other devices via an AP of a wireless LAN in an infrastructure mode. In addition, the wireless communication interface 913 directly communicates with other devices in a direct communication mode such as an ad hoc mode or Wi-Fi Direct.

Note that, whereas one of two terminals operates as an AP in Wi-Fi Direct unlike in an ad hoc mode, communication is performed directly between the terminals.

The wireless communication interface 913 typically includes a baseband processor, an RF (Radio Frequency) circuit, a power amplifier, and the like. The wireless communication interface 913 may be a one-chip module on which a memory that stores a communication control program, a processor that executes the program, and related circuits are integrated.

In addition to a wireless LAN scheme, the wireless communication interface 913 may support another type of wireless communication scheme such as a near field communication scheme, a proximity wireless communication scheme, or a cellular communication scheme.

The antenna switch 914 switches the connection destination of the antenna 915 between a plurality of circuits (e.g., circuits for different wireless communication schemes) included in the wireless communication interface 913.

The antenna 915 has a single antenna element or a plurality of antenna elements (e.g., a plurality of antenna elements included in MIMO (Multiple Input Multiple Output) antennas), and is used for transmission and reception of wireless signals by the wireless communication interface 913.

Note that the smartphone 900 is not limited to the example in FIG. 10, and may include a plurality of antennas (e.g., an antenna for wireless LAN, an antenna for a proximity wireless communication scheme, etc.). In that case, the antenna switch 914 may be omitted from the configuration of the smartphone 900.

The bus 917 interconnects the processor 901, the memory 902, the storage 903, the external connection interface 904, the camera 906, the sensor 907, the microphone 908, the input device 909, the display device 910, the speaker 911, the wireless communication interface 913, and the auxiliary controller 919.

The battery 918 supplies electric power to each block of the smartphone 900 depicted in FIG. 10 via power supply lines, parts of which are depicted by broken lines in the figure. For example, the auxiliary controller 919 causes minimum necessary functions of the smartphone 900 to operate in a sleep mode.

In the smartphone 900 depicted in FIG. 10, for example, the AP 1, the AP 2, the communication control section 111, or the control section 130 in FIG. 2 or the Non-AP STA 1 or STA 2, the communication control section 211, or the control section 230 in FIG. 3 may be implemented in the wireless communication interface 913. In addition, at least some of these functions may be implemented in the processor 901 or the auxiliary controller 919.

Note that the smartphone 900 may operate as a wireless AP (software AP) by causing the processor 901 to execute an AP function on the application level. In addition, the wireless communication interface 913 may have a wireless AP function.

Further, the smartphone 900 may include a biometric authenticating section (fingerprint authentication, palm shape authentication, sound authentication, blood vessel authentication, facial authentication, iris authentication, and retina authentication). At that time, the wireless communication interface 913 in which the AP 1, the AP 2, the communication control section 111, and the control section 130 in FIG. 2 or the STA 1, the STA 2, the communication control section 211, and the control section 230 in FIG. 3 are implemented is configured to receive power supply from the same battery 918 that supplies power to at least any one of the display device 910, the speaker 911, and the biometric authenticating section.

In addition, either the display device 910 or the speaker 911 in the smartphone 900 outputs information on the basis of communication by the wireless communication interface 913 with an external device. At that time, as the information, information related to the present technology may be output from at least the display device 910 or the speaker 911.

### <<Configuration Example of Vehicle-Mounted Device>>

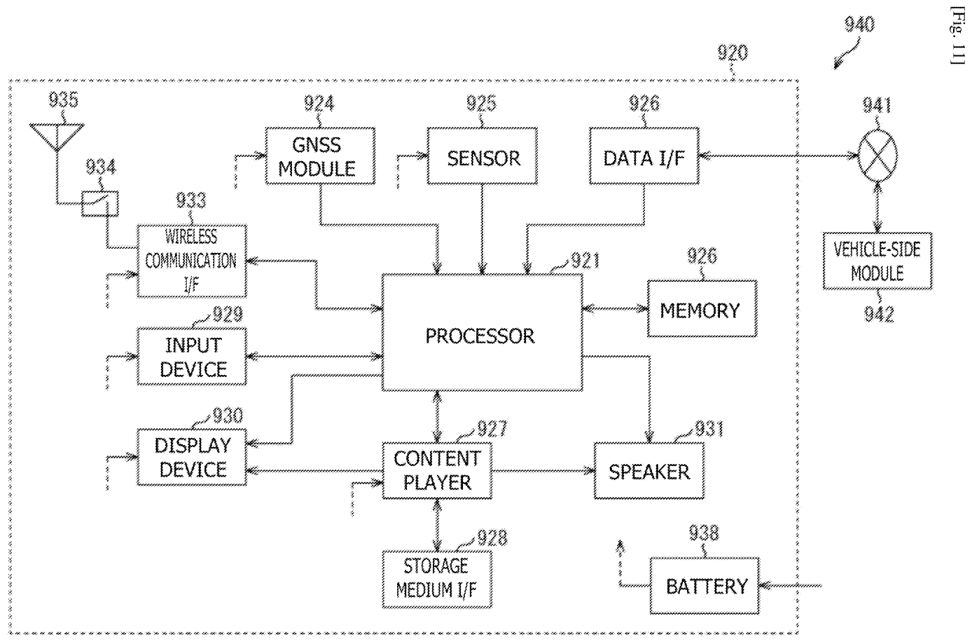

FIG. 11 is a block diagram depicting a schematic configuration example of a vehicle-mounted device 920 to which the present technology is applied.

The vehicle-mounted device 920 includes a processor 921, a memory 922, a GNSS (Global Navigation Satellite System: global navigation satellite system) module 924, a sensor 925, a data interface 926, a content player 927, and a storage medium interface 928. In addition, the vehicle-mounted device 920 includes an input device 929, a display device 930, a speaker 931, a wireless communication interface 933, an antenna switch 934, an antenna 935, and a battery 938.

For example, the processor 921 may be a CPU or a SoC, and controls a navigation function and other functions of the vehicle-mounted device 920. In addition, the processor 921 can also control vehicle drive systems such as a brake, an accelerator, or a steering wheel on the basis of information obtained through communication according to the present technology.

The memory 922 includes a RAM and a ROM, and stores programs to be executed by the processor 921 and data.

The GNSS module 924 measures the position (e.g., the latitude, the longitude, and the altitude) of the vehicle-mounted device 920 by using GNSS signals received from GNSS satellites.

For example, the sensor 925 includes a sensor group including a gyro sensor, a geomagnetic sensor, a barometric pressure sensor, and the like.

For example, the data interface 926 is connected to an in-vehicle network 941 via a terminal which is not depicted, and acquires data generated on the vehicle side such as in-vehicle data.

The content player 927 reproduces content stored on a storage medium (e.g., a CD or a DVD) inserted into the storage medium interface 928.

For example, the input device 929 includes a touch sensor that detects a touch on a screen of the display device 930, buttons, switches, and the like, and accepts manipulation or information input from a user.

The display device 930 has a screen such as an LCD or an OLED display, and displays images of the navigation function or reproduced content.

The speaker 931 outputs sounds of the navigation function or the reproduced content.

Note that the navigation function or the function of the content player 927 in the vehicle-mounted device 920 is optional. The navigation function or the content player 927 may be eliminated from the configuration of the vehicle-mounted device 920.

The wireless communication interface 933 supports one or more of wireless LAN standards such as IEEE 802.11a, 11b, 11g, 11n, 11ac, 11ad, 11ax, 11ay, or 11be, and executes wireless communication. The wireless communication interface 933 communicates with other devices via an AP of a wireless LAN in an infrastructure mode. In addition, the wireless communication interface 933 directly communicates with other devices in a direct communication mode such as an ad hoc mode or Wi-Fi Direct.

The wireless communication interface 933 typically includes a baseband processor, an RF circuit, a power amplifier, and the like. The wireless communication interface 933 may be a one-chip module on which a memory that stores a communication control program, a processor that executes the program, or related circuits are integrated. In addition to a wireless LAN scheme, the wireless communication interface 933 may support another type of wireless communication scheme such as a near field communication scheme, a proximity wireless communication scheme, or a cellular communication scheme.

The antenna switch 934 switches the connection destination of the antenna 935 between a plurality of circuits included in the wireless communication interface 933.

The antenna 935 has a single antenna element or a plurality of antenna elements, and is used for transmission and reception of wireless signals by the wireless communication interface 933.

Note that the vehicle-mounted device 920 is not limited to the example of FIG. 11, and may include a plurality of antennas 935. In that case, the antenna switch 934 may be omitted from the configuration of the vehicle-mounted device 920.

The battery 938 supplies electric power via power supply lines, parts of which are depicted by broken lines in the figure. In the vehicle-mounted device 920 depicted in FIG. 11, for example, the AP 1, the AP 2, the communication control section 111, and the control section 130 in FIG. 2 or the STA 1, the STA 2, the communication control section 211, and the control section 230 in FIG. 3 may be implemented in the wireless communication interface 933. In addition, at least some of these functions may be implemented in the processor 921.

In addition, the wireless communication interface 933 may operate as the wireless communication device 100 or the wireless communication device 200 mentioned above, and provide wireless connection to a terminal used by a user in a vehicle.

In addition, the present technology may be realized as a vehicle-mounted system (or vehicle) 940 including one or more blocks of the vehicle-mounted device 920 mentioned above, the in-vehicle network 941, and a vehicle-side module 942. The vehicle-side module 942 generates vehicle-side data such as the vehicle speed, the engine revolution speed, or malfunction information, and outputs the generated data to the in-vehicle network 941.

### <<Configuration Example of Wireless AP>>

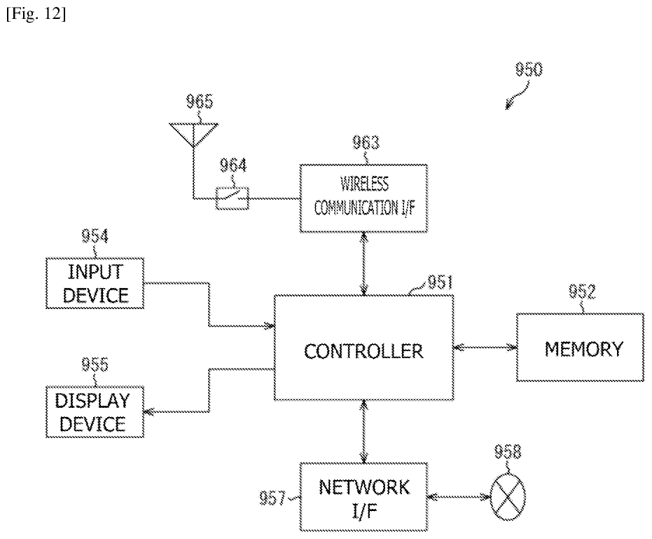

FIG. 12 is a block diagram depicting a schematic configuration example of a wireless AP 950 to which the present technology is applied.

The wireless AP 950 includes a controller 951, a memory 952, an input device 954, a display device 955, a network interface 957, a wireless communication interface 963, an antenna switch 964, and an antenna 965.

For example, the controller 951 may be a CPU or a DSP (Digital Signal processor), and causes various functions (e.g., access restriction, routing, encryption, firewall, log management, etc.) of the IP (Internet Protocol) layer and layers higher than the IP layer of the wireless AP 950 to operate.

The memory 952 includes a RAM and a ROM, and stores programs to be executed by the controller 951 and various pieces of control information (e.g., terminal lists, routing tables, encryption keys, security settings, logs, etc.).

For example, the input device 954 includes buttons, switches, and the like, and accepts manipulation from a user.

The display device 955 includes an LED lamp and the like, and displays the operation status of the wireless AP 950.

The network interface 957 is a cable communication interface by which the wireless AP 950 is connected to a cable communication network 958. The network interface 957 may have a plurality of connection terminals. The cable communication network 958 may be a LAN of Ethernet (registered trademark) or the like or may be a WAN (Wide Area Network).

The wireless communication interface 963 supports one or more of wireless LAN standards such as IEEE 802.11a, 11b, 11g, 11n, 11ac, 11ad, 11ax, 11ay, or 11be, and, as an AP, provides wireless connection to nearby terminals.

The wireless communication interface 963 typically includes a baseband processor, an RF circuit, a power amplifier, and the like.

The wireless communication interface 963 may be a one-chip module on which a memory that stores a communication control program, a processor that executes the program, or related circuits are integrated.

The antenna switch 964 switches the connection destination of the antenna 965 between a plurality of circuits included in the wireless communication interface 963. The antenna 965 has a single antenna element or a plurality of antenna elements, and is used for transmission and reception of wireless signals by the wireless communication interface 963.

In the wireless AP 950 depicted in FIG. 12, for example, the AP 1, the AP 2, the communication control section 111, and the control section 130 in FIG. 2 or the STA 1, the STA 2, the communication control section 211, and the control section 230 in FIG. 3 may be implemented also in the wireless communication interface 963. In addition, at least some of these functions may be implemented in the controller 951.

Note that the embodiment mentioned above is depicted as an example for embodying the present technology, and matters in the embodiment and invention specifying matters in claims are correlated, respectively. Similarly, invention specifying matters in claims and matters in the embodiment of the present technology that are given names which are identical to those of the invention specifying matters are correlated, respectively. However, the present technology is not limited to the embodiment, and can be embodied by making various modifications to the embodiment within the scope not departing from the gist thereof.

In addition, processing procedures explained in the embodiment mentioned above may be interpreted as methods having the series of procedures, and also may be interpreted as programs for causing a computer to execute the series of procedures or a recording medium storing the programs.

For example, as the recording medium, a CD (Compact Disc), an MD (MiniDisc), a DVD (Digital Versatile Disc), a memory card, a Blue-ray disc (Blu-ray (registered trademark) Disc), or the like can be used.

Note that, in the present specification, a system means a set of a plurality of constituent elements (devices, modules (components), etc.), and it does not matter whether or not all the constituent elements are located in a single housing. Accordingly, a plurality of devices housed in separate housings and connected via a network and one device with one housing having housed therein a plurality of modules are both systems.

In addition, advantages described in the present specification are presented merely for illustrative purposes, and not for limiting the advantages. There may be advantages other than those described in the present specification.

Embodiments of the present technology are not limited to the embodiment mentioned above, and can be changed in various manners within the scope not departing from the gist of the present technology.

For example, the present technology can be configured as cloud computing in which one functionality is shared among a plurality of devices via a network, and is processed by the plurality of devices in cooperation with each other.

In addition, other than being executed on one device, each step explained in a flowchart mentioned above can be shared among and executed by a plurality of devices.

Further, in a case where one step includes a plurality of processes, other than being executed on one device, the plurality of processes included in the one step can be shared among and executed by a plurality of devices.

The present embodiment can also have the following configuration.

### Notes

(1) A wireless communication control device comprises circuitry configured to connect to a first device via a first link and a second link; communicate with the first device via the first link during a first period; and transmit, via the first link, a re-transmission request to the first device for schedule information for scheduling communication over the second link.
(2) The wireless communication control device of (1), wherein the circuitry is configured to transmit the retransmission request in response to a failure of reception of the scheduling information via the second link during the first period.
(3) The wireless communication control device of (1) or (2), wherein the first device is an access point (AP) device, and the wireless communication control device is a non-AP device.
(4) The wireless communication control device of any of (1)-(3), wherein the first device is an AP multi-link device (MLD), and the wireless communication control device is a non-AP MLD.
(5) The wireless communication control device of any of (1)-(4), wherein in a case that the circuitry experiences interference, the circuitry is configured to communicate via only one of the first link or the second link at a time.
(6) The wireless communication control device of any of (1)-(5), wherein the first device is connected to both the wireless communication control device and a second device via the first link and the second link.
(7) The wireless communication control device of any of (1)-(6), wherein the circuitry is further configured to receive the schedule information on the basis of the retransmission request via at least one of the first link or the second link.
(8) The wireless communication control device of any of (1)-(7), wherein the schedule information is transmitted to the wireless communication control device and the second device from the first device via the second link.
(9) The wireless communication control device of any of (1)-(8), wherein the schedule information is simultaneously transmitted to the wireless communication control device and the second device from the first device.
(10) The wireless communication control device of any of (1)-(9), wherein the schedule information includes instructions for power saving operation.
(11) The wireless communication control device of any of (1)-(10), wherein the schedule information includes any of a target wake time period, types or priorities of signals to be transmitted, and information regarding a designation of device to perform transmission.
(12) The wireless communication control device of any of (1)-(11), wherein the schedule information indicates periods of time the wireless communication control device is to be active and not active.
(13) The wireless communication control device of any of (1)-(12), wherein the circuitry is configured to transition to a doze state during a period indicated as not active by the schedule information.
(14) The wireless communication control device of any of (1)-(13), wherein the schedule information indicates periods of time the wireless communication control device is to be active and not active and periods of time the second device is to be active and not active.
(15) The wireless communication control device of any of (1)-(14), wherein the retransmission request indicates a frame control, a frame length, and a control identifier, and
   the control identifier includes information indicating the retransmission request for the scheduling information.
(16) The wireless communication control device of any of (1)-(15), further comprising:
   a transmitter; and
   a memory, wherein the wireless communication control device is a smartphone.
(17) The wireless communication control device of any of (1)-(16), wherein the wireless communication control device is a component within a smartphone.
(18) The wireless communication control device of any of (1)-(17), wherein the schedule information includes a communication period during which two devices including at least one of the wireless communication control device or the second device are able to perform P2P communication in a frequency band of the second link preferentially or exclusively, and identifiers of the two devices.
(19) The wireless communication control device of any of (1)-(18), wherein the schedule information includes:
   a period during which an AP device selected from the first device and one or more other AP devices having coverage that overlaps coverage of the first device, and one or more non-AP devices belonging to a Basic Service Set (BSS) of the selected AP device are able to perform communication preferentially or exclusively on the second link, and
   an identifier of the selected AP device or an identifier of the BSS.
(20) The wireless communication control device of any of (1)-(19), wherein the schedule information includes a period during which the wireless communication control device performs a sounding operation for Multiple Input Multiple Output (MIMO).
(21) The wireless communication control device of any of (1)-(20), wherein the schedule information includes a period during which the wireless communication control device performs at least one of transmission and reception of a signal in a frequency band of the second link and thereby performs positional measurement.
(22) The wireless communication control device of any of (1)-(21), wherein the schedule information includes a period of an operation performed by the wireless communication control device regarding the second link, and the period is defined as having a start point at a transmission timing of a beacon signal transmitted from the first device at a certain time interval.
(23) The wireless communication control device of any of (1)-(22), wherein the retransmission request includes information representing that data that needs to be transmitted with a short delay is retained, and the circuitry is configured to acquire schedule information updated in response to the information included in the retransmission request.
(24) The wireless communication control device of any of (1)-(23), wherein the circuitry is configured to transmit a first frame including the retransmission request and a request for resetting media information and receive a second frame including the schedule information and the reset media information.
(25) The wireless communication control device of any of (1)-(24), wherein the second frame includes a trigger frame that triggers uplink multiuser transmission performed by one or more of the wireless communication control device and a second device connected, via the first link and the second link, to the first device.
(26) The wireless communication control device of any of (1)-(25), wherein the schedule information includes information regarding Target Wake Time (TWT).
(27) A wireless communication control device, comprising: circuitry configured to
   connect with a first device via a first link and a second link;
   communicate with the first device via the first link during a first period;
   transmit, to the first device via the second link during the first period, schedule information for scheduling communication over the second link; and
   receive a retransmission request, from the first device via the first link, for re-transmission of the scheduling information via the second link.
(28) The wireless communication control device of (27), wherein the circuitry receives the retransmission request, via the first link, in a case that the first device fails to receive the scheduling information via the second link.
(29) The wireless communication control device of (27) or (28), wherein the wireless communication control device is an access point (AP), and the first device is a non-AP device.
(30) The wireless communication control device of any of (27)-(29), wherein the circuitry is further configured to retransmit the scheduling information via the second link in response to reception of the retransmission request.
(31) The wireless communication control device of any of (27)-(30), wherein the circuitry is further configured to
   connect with the first device via the first link and the second link, and
   connect with a second device via the first link and the second link.
(32) The wireless communication control device of any of (27)-(31), wherein the circuitry is configured to simultaneously transmit the schedule information to the first device and the second device via the second link.
(33) A wireless communication control method, comprising:
   connecting, by a first device, to a second device via a first link and a second link;
   communicating, by the first device, with the second device via the first link during a first period; and
   transmitting, via the first device via the first link, a retransmission request to the second device for the schedule information for scheduling communication over the second link.
(34) A wireless communication control device comprising:
   a control section that controls
   a first wireless communication section of a first wireless communication device connected wirelessly with a second wireless communication device on a first link and a second link, the first wireless communication section performing first communication with the second wireless communication device on the first link, and
   a second wireless communication section of the first wireless communication device,
   the second wireless communication section performing second communication with the second wireless communication device on the second link, wherein
   the control section is configured to perform control such that schedule information of communication on the second link of a third wireless communication device connected wirelessly with the second wireless communication device on the first link and the second link is acquired, and
   the first wireless communication section transmits a retransmission request for the schedule information in response to a failure of reception of the schedule information by the second wireless communication section in a period during which the first wireless communication section is performing the first communication.
(35) The wireless communication control device of (34), wherein the second wireless communication section is not capable of correctly receiving the schedule information due to signal interference from the first wireless communication section while the first wireless communication section is performing the first communication.
(36) The wireless communication control device of (35), wherein the schedule information includes a period of an operation performed by the third wireless communication device regarding the second link, and the period is a period defined as having a start point at a transmission timing of a beacon signal transmitted from the second wireless communication device at a certain time interval.
(37) The wireless communication control device of any of (34)-(36), wherein the schedule information includes schedule information regarding a power saving operation of the third wireless communication device.
(38) The wireless communication control device of (37), wherein the schedule information includes a period during which the third wireless communication device is able to transition to a Doze state.
(39) The wireless communication control device of (37) or (38), wherein the schedule information includes a period during which the third wireless communication device is able to transmit or receive a signal after returning from a Doze state.
(40) The wireless communication control device of any of (34)-(39), wherein the schedule information includes at least one of a type or a priority of a signal that the third wireless communication device is permitted to transmit.
(41) The wireless communication control device of any of (34)-(40), wherein the schedule information includes a communication period during which two of a plurality of wireless communication devices including the first wireless communication device and the third wireless communication device are able to perform P2P communication in a frequency band of the second link preferentially or exclusively, and identifiers of the two wireless communication devices.
(42) The wireless communication control device of any of (34)-(41), wherein the second wireless communication device is an access point device, and the schedule information includes
   a period during which a particular access point device selected from the access point device and one or more other access point devices having coverage that overlaps coverage of the access point device, and one or more wireless communication devices belonging to a BSS (Basic Service Set) of the selected access point device is able to perform communication preferentially or exclusively on the second link, and an identifier of the selected access point device or an identifier of the BSS.
(43) The wireless communication control device of any of (34)-(42), wherein the schedule information includes a period during which the third wireless communication device is caused to perform a sounding operation for MIMO (Multiple Input Multiple Output).
(44) The wireless communication control device of any of (34)-(43), wherein the schedule information includes a period during which the third wireless communication device is caused to perform at least one of transmission and reception of a signal in a frequency band of the second link and thereby perform positional measurement.
(45) The wireless communication control device of any of (34)-(44), wherein the control section acquires the schedule information received at at least one of the first wireless communication section and the second wireless communication section after the retransmission request is transmitted, and the control section controls the second wireless communication section according to the schedule information.
(46) The wireless communication control device of any of (34)-(45), wherein the retransmission request includes information representing that data that needs to be transmitted with a short delay is retained, and the control section acquires schedule information updated in response to the information included in the retransmission request.
(47) The wireless communication control device of any of (34)-(46), further comprising: the second wireless communication section, wherein
   the second wireless communication section is configured to be capable of receiving a first frame including the schedule information and media information regarding a use status of a wireless medium,
   the control section performs control such that the first wireless communication section transmits a second frame including the retransmission request and a request for resetting the media information, in response to a failure of reception of the first frame by the second wireless communication section in a period during which the first communication is being performed, and
   the second wireless communication section receives a third frame including the schedule information and the reset media information.
(48) The wireless communication control device of (47), wherein the third frame is a frame formed by concatenating a fourth frame that includes the reset media information and also requires a response to the second wireless communication device and a fifth frame including the schedule information, the fourth frame and the fifth frame being concatenated in this order.
(49) The wireless communication control device of (47) or (48), wherein the third frame is a frame formed by concatenating a fifth frame including the schedule information and a sixth frame that includes the reset media information and also does not require a response to the second wireless communication device, the fifth frame and the sixth frame being concatenated in this order.
(50) The wireless communication control device of (48), wherein the fourth frame is a trigger frame that triggers uplink multiuser transmission performed by one or more of the first wireless communication device and the third wireless communication device.
(51) The wireless communication control device of any of (34)-(50), wherein the schedule information includes information regarding TWT (Target Wake Time).
(52) The wireless communication control device of any of (34)-(51), wherein the control section performs control such that the first wireless communication section transmits the retransmission request in response to detection of a failure of the reception by the second wireless communication section in at least a part of a period during which the first wireless communication section is transmitting data to the second wireless communication device.
(53) A wireless communication control device comprising:
   a control section that controls
   a first wireless communication section of a wireless communication device that is connected wirelessly with each of a first wireless communication device and a second wireless communication device on a first link, and connected wirelessly with each of the first wireless communication device and the second wireless communication device on a second link, the first wireless communication section performing first communication with the first wireless communication device and the second wireless communication device on the first link, and
   a second wireless communication section of the wireless communication device, the second wireless communication section performing second communication with the first wireless communication device and the second wireless communication device on the second link, wherein
   the control section performs control such that
   the second wireless communication section transmits schedule information of the second communication of the first wireless communication device to the second wireless communication device in a period during which the first wireless communication section is performing the first communication with the second wireless communication device, and
   at least one of the first wireless communication section and the second wireless communication section transmits the schedule information to the second wireless communication device in response to reception of a retransmission request for the schedule information from the second wireless communication device at the first wireless communication section.

### REFERENCE SIGNS LIST

1, 2: Non-AP MLD
100: AP MLD
100: Wireless communication device
110: Communication section
111: Communication control section
112: Communication storage section
113: Common data processing section
121: Individual data processing section
122: Signal processing section
123: Wireless interface section
124: Amplifying section
130: Control section
140: Storage section
150: Antenna
200: Communication device
210: Communication section
211: Communication control section
212: Communication storage section
213: Common data processing section
221: Individual data processing section
221: Signal processing section
222: Signal processing section
223: Wireless interface section
224: Amplifying section
230: Control section
240: Storage section
250: Antenna
401: Data signal
402: Signal
405: Signal
406: Doze state
407: Signal
408: Signal
409: Doze state
804: Bus
805: Input/output interface
806: Input section
807: Output section
808: Storage section
809: Communication section
810: Drive
811: Removable medium
900: Smartphone
901: Processor
902: Memory
903: Storage
904: External connection interface
906: Camera
907: Sensor
908: Microphone
909: Input device
910: Display device
911: Speaker
913: Wireless communication interface
914: Antenna switch
915: Antenna
917: Bus
918: Battery
919: Auxiliary controller
920: Vehicle-mounted device
921: Processor
922: Memory
924: GNSS module
925: Sensor
926: Data interface
927: Content player
928: Storage medium interface
929: Input device
930: Display device
931: Speaker
933: Wireless communication interface
933: Wireless communication interface
934: Antenna switch
935: Antenna
938: Battery
940: Vehicle-mounted system (or vehicle)
941: In-vehicle network
942: Vehicle-side module
951: Controller
952: Memory
954: Input device
955: Display device
957: Network interface
958: Cable communication network
963: Wireless communication interface
964: Antenna switch
965: Antenna

1. A wireless communication control device, comprising:
circuitry configured to
connect to a first device via a first link and a second link;
communicate with the first device via the first link during a first period; and
transmit, via the first link, a retransmission request to the first device for schedule information for scheduling communication over the second link.

2. The wireless communication control device of claim 1, wherein the circuitry is configured to transmit the retransmission request in response to a failure of reception of the scheduling information via the second link during the first period.

3. The wireless communication control device of claim 1, wherein the first device is an access point (AP) device, and the wireless communication control device is a non-AP device.

4. The wireless communication control device of claim 3, wherein the first device is an AP multi-link device (MLD), and the wireless communication control device is a non-AP MLD.

5. The wireless communication control device of claim 1, wherein in a case that the circuitry experiences interference, the circuitry is configured to communicate via only one of the first link or the second link at a time.

6. The wireless communication control device of claim 1, wherein the first device is connected to both the wireless communication control device and a second device via the first link and the second link.

7. The wireless communication control device of claim 1, wherein the circuitry is further configured to receive the schedule information on the basis of the retransmission request via at least one of the first link or the second link.

8. The wireless communication control device of claim 6, wherein the schedule information is transmitted to the wireless communication control device and the second device from the first device via the second link.

9. The wireless communication control device of claim 8, wherein the schedule information is simultaneously transmitted to the wireless communication control device and the second device from the first device.

10. The wireless communication control device of claim 1, wherein the schedule information includes instructions for power saving operation.

11. The wireless communication control device of claim 1, wherein the schedule information includes any of a target wake time period, types or priorities of signals to be transmitted, and information regarding a designation of device to perform transmission.

12. The wireless communication control device of claim 1, wherein the schedule information indicates periods of time the wireless communication control device is to be active and not active.

13. The wireless communication control device of claim 12, wherein the circuitry is configured to transition to a doze state during a period indicated as not active by the schedule information.

14. The wireless communication control device of claim 6, wherein the schedule information indicates periods of time the wireless communication control device is to be active and not active and periods of time the second device is to be active and not active.

15. The wireless communication control device of claim 1, wherein the retransmission request indicates a frame control, a frame length, and a control identifier, and the control identifier includes information indicating the retransmission request for the scheduling information.

16. The wireless communication control device of claim 6, wherein the schedule information includes a communication period during which two devices including at least one of the wireless communication control device or the second device are able to perform P2P communication in a frequency band of the second link preferentially or exclusively, and identifiers of the two devices.

17. The wireless communication control device of claim 3, wherein the schedule information includes:
a period during which an AP device selected from the first device and one or more other AP devices having coverage that overlaps coverage of the first device, and one or more non-AP devices belonging to a Basic Service Set (BSS) of the selected AP device are able to perform communication preferentially or exclusively on the second link, and
an identifier of the selected AP device or an identifier of the BSS.

18. The wireless communication control device of claim 1, wherein the schedule information includes a period during which the wireless communication control device performs a sounding operation for Multiple Input Multiple Output (MIMO).

19. The wireless communication control device of claim 1, wherein the schedule information includes a period during which the wireless communication control device performs at least one of transmission and reception of a signal in a frequency band of the second link and thereby performs positional measurement.

20. The wireless communication control device of claim 1, wherein the schedule information includes a period of an operation performed by the wireless communication control device regarding the second link, and the period is defined as having a start point at a transmission timing of a beacon signal transmitted from the first device at a certain time interval.

21. The wireless communication control device of claim 7, wherein the retransmission request includes information representing that data that needs to be transmitted with a short delay is retained, and the circuitry is configured to acquire schedule information updated in response to the information included in the retransmission request.

22. The wireless communication control device of claim 1, wherein the circuitry is configured to transmit a first frame including the re-transmission request and a request for resetting media information and receive a second frame including the schedule information and the reset media information.

23. The wireless communication control device of claim 22, wherein the second frame includes a trigger frame that triggers uplink multiuser transmission performed by one or more of the wireless communication control device and a second device connected, via the first link and the second link, to the first device.

24. The wireless communication control device of claim 1, wherein the schedule information includes information regarding Target Wake Time (TWT).

25. A wireless communication control device, comprising:
circuitry configured to
connect with a first device via a first link and a second link;
communicate with the first device via the first link during a first period;
transmit, to the first device via the second link during the first period, schedule information for scheduling communication over the second link; and
receive a retransmission request, from the first device via the first link, for retransmission of the scheduling information via the second link.
